(19) United States
(12) Patent Application Publication
(10) Pub. No.: US 2013/0098488 A1
(43) Pub. Date: Apr. 25, 2013

(54) HIGH PRESSURE POLYMER VALVE PLUG COMPONENTS AND SYSTEMS

(71) Applicants: Michael H. Weems, Marina, CA (US); John P. Smitherman, Salinas, CA (US)

(72) Inventors: Michael H. Weems, Marina, CA (US); John P. Smitherman, Salinas, CA (US)

(21) Appl. No.: 13/279,180

(22) Filed: Oct. 21, 2011

(51) Int. Cl. F16K 43/00

(52) U.S. Cl. 137/800

(57) ABSTRACT

A valve including a plastic valve plug capable of operation at 5000 PSI is described. Taken alone or in combination, various features including the design and material selection of the valve plug account for the heretofore-unknown performance achieved.

### BACKGROUND

A particularly difficult challenge is faced in connection with the design of flow control components intended to operate in a range up to 5000 PSI. Valves incorporating a synthetic rubber or fluoropolymer elastomer seat, such as Viton® from DuPont Performance Elastomers L.L.C. typically fail by extruding the polymer through the valve orifice at about 1000 PSI. A hardened VITON material can extend the operating range up to about 2000 PSI.

Thus, it is clear why manufactures resort to the use of metal seats and plugs for valves to control pressures above 2000 PSI. Yet, all-metal valve flow control components (i.e., seats and plugs) are technically difficult to manufacture, expensive, and burdensome to set up in production. Accordingly, there exists a need for improvement in the field of high pressure flow control. Through one or more features, the present invention meets this need.

### SUMMARY

In the invention, a modified globe-type valve is provided. It includes a movable plug element and a stationary seat. With a face of the plug positioned against the valve seat, no flow or substantially no flow (i.e., as little as 1% leak by) is permitted across an internal baffle in the valve. The body of the plug may be fit to any known valve actuator or support components. Advantageously, it is carried by a “spider” spring as typically used (e.g., in the Brooks Instrument COPLANAR valve or other examples). Preload applied to the spring maintains the valve in a normally-off/closed configuration. Energizing a servo coil produces a magnetic field to draw an armature holding the plug body away from the valve seat to regulate flow.

Electronic control is achieved using feedback control methods such as proportional control, integral control, proportional-integral (PI) control, derivative control, proportional-derivative (PD) control, integral-derivative (ID) control, and proportional-integral-derivative (PID). Skilled artisans will appreciate that the functions described can be embodied directly in hardware, in a software module executed by a processor, or in a combination of the two.

Novel elements embodied in the invention include the plug body and associated armature. The plug is made of plastic. As such, it is economically produced. It can be made on a lathe/screw machine from rod stock; it can be injection molded (e.g., into the mold as a powder, then sintered). In any event, it is much less expensive to produce than a comparable metal valve part.

Certain features enable use of a plastic valve seat body for a valve to operate up to about 5000 PSI or more. The device is adapted for repetitive use of at least thousands of cycles and upwards of millions of cycles without losing calibration. The subject invention can be used for any valve, including a valves operative to 5000 PSI, in which the improvement comprises use of a plastic valve plug.

The present invention comprises a valve including a plastic valve plug capable of operation at 5000 PSI. Another aspect of the invention concerns valve plugs engineered for such purposes. Yet another aspect of the invention includes the method of manufacture for the plugs. Still another covers the use of the subject valve plugs.

Aspects of the present invention include the subject devices, assemblies in which they are included, methods of use and methods of manufacture. A number of aspects of such manufacture are discussed above. More detailed discussion is presented in connection with the figures below. Other systems, methods, features and advantages will be or will become apparent to one with skill in the art upon examination of the following figures and detailed description. It is intended that all such additional systems, methods, features and advantages be included within this description, be within the scope of the inventive subject matter, and be protected by the accompanying claims. It is also intended that the inventive subject matter not be limited to the details of the example embodiments nor any representations made in this summary section.

### BRIEF DESCRIPTION OF THE FIGURES

The figures provided herein are not necessarily drawn to scale, with some components and features exaggerated for clarity. Variations of the inventive subject matter from the embodiments pictured are contemplated. Accordingly, the figures are not intended to limit the scope of the claims.

FIG. 1 is a perspective view including the valve plug and actuator;

FIG. 2 is a side-sectional view of a valve system including a valve plug and armature details provided according to aspects of the present invention; and

FIG. 3 is an analytical view of the valve plug body illustrating stress in simulated use.

### DETAILED DESCRIPTION

Various exemplary embodiments of the inventive subject matter are described below. Reference is made to these examples in a non-limiting sense. They are provided to illustrate more broadly applicable aspects of the inventive subject matter. Various changes may be made and equivalents may be substituted without departing from the true spirit and scope of the inventive subject matter. In addition, many modifications may be made to adapt a particular situation, material, composition of matter, process, process act(s) or step(s) to the objective(s), spirit or scope of the inventive subject matter. All such modifications are intended to be within the scope of the claims made herein.

### Valve Construction and Environment

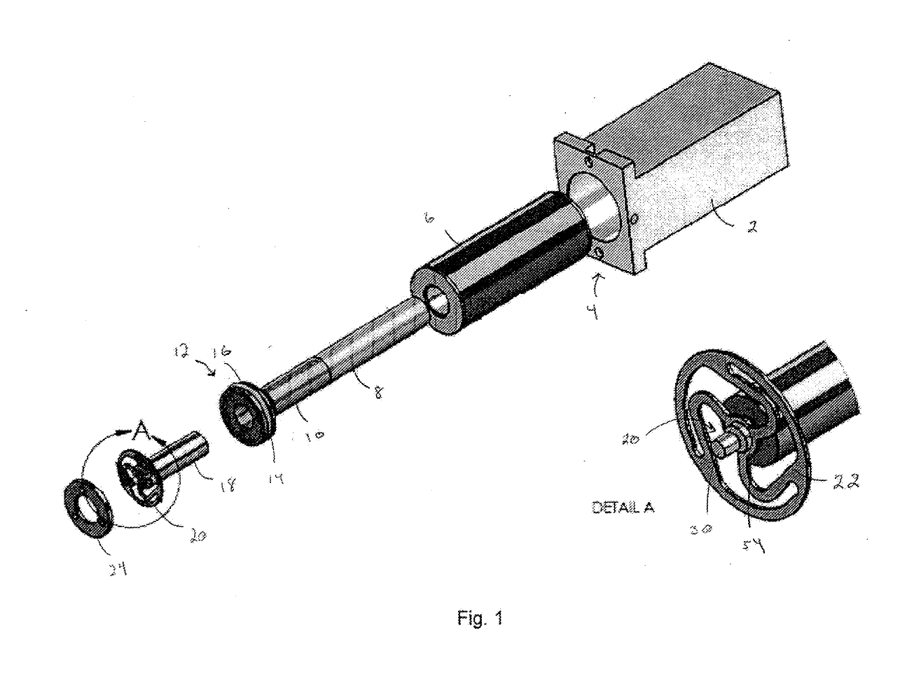

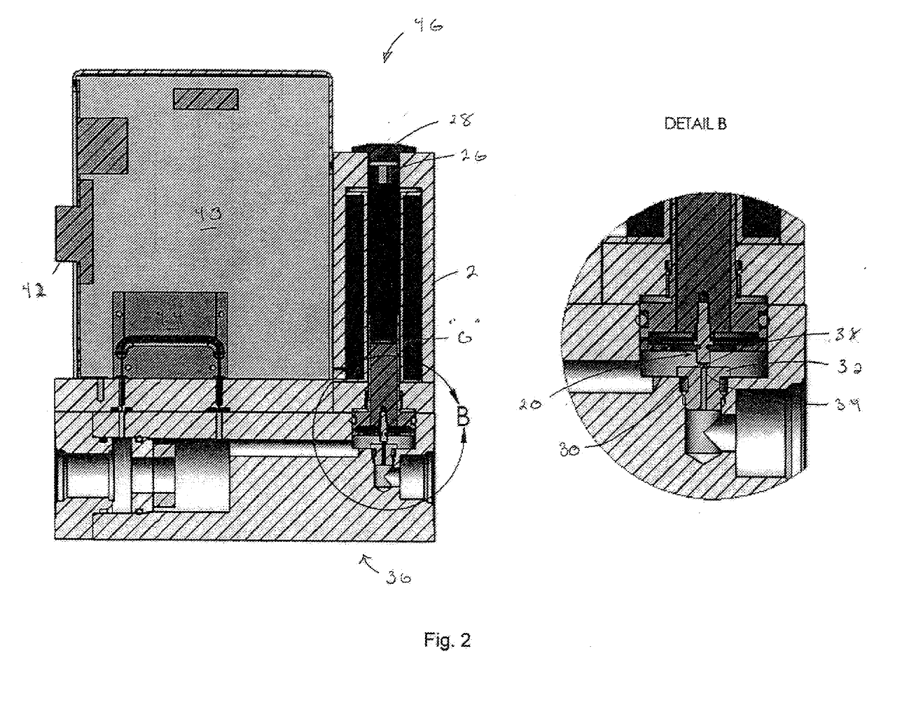

Mass flow controllers (MFCs) are available in a wide variety of styles, sizes and performance ratings in order to meet various specialized applications. The primary components of an MFC are the restrictor body, sensor, circuit board, valve body/bonnet, stem/plunger assembly and valve seat and orifice body. The “active” components of such a device are illustrated in FIG. 1. An example of how these components are incorporated in an MFC is illustrated in FIG. 2.

Turning to FIG. 1, a coil enclosure 2 includes mounting brackets 4 for bolting onto an MFC restrictor body 36 as shown in FIG. 2. Coil enclosure 2 further includes a recess to receive an electromagnetic coil 6 therein. A ferromagnetic valve post 8 (e.g., comprising grade 430 stainless steel alloy) is received by within the coil. A non magnetic (e.g., comprising 316 stainless steel alloy) sleeve 10 is coupled, preferably welded, to the post 8. The sleeve 10 terminates in a seal sub-assembly 12 including an O-ring 14 set in a slot 16.

An armature element 18 receives the valve plug 20 and carries a spider spring 22 secured by a clamp ring 24 for sandwiching the spring 22 to the seal subassembly 12. The armature 18 also comprises a ferromagnetic material (e.g., 430 stainless). It is received within the sleeve 10 and responsive to magnetic interaction with the post 8, when the coil 6 is energized.

The relation of parts when assembled is shown in FIG. 2, in which a magnetic working gap “G” is open when the device is un-energized. The gap G closes (to various degree) upon application of energy. This activity opens the valve from its normally-closed position as set by applying a preload to the spider spring 22 through a threaded interface tuned via socket 26 set underneath sealing cap 28. In use, the proximity of the bearing surface or “face” 30 of the plug element that controls flow through the orifice 32 formed in the orifice body 34 received in restrictor body 36.

Armature 18 (and hence—plug) position is manipulated by logic/programming embedded in or loaded onto a printed circuit board (PCB) 40, optionally via data communication port 42. Otherwise, the port 42 is used for device networking, etc.

In any case, the programming is responsive to the mass flow sensor 44 subassembly in regulating flow through MFC 46. Such a sensor 44 is optionally a thermal capillary type mass flow sensor arrangement.

### Valve Plug Design and Material Selection

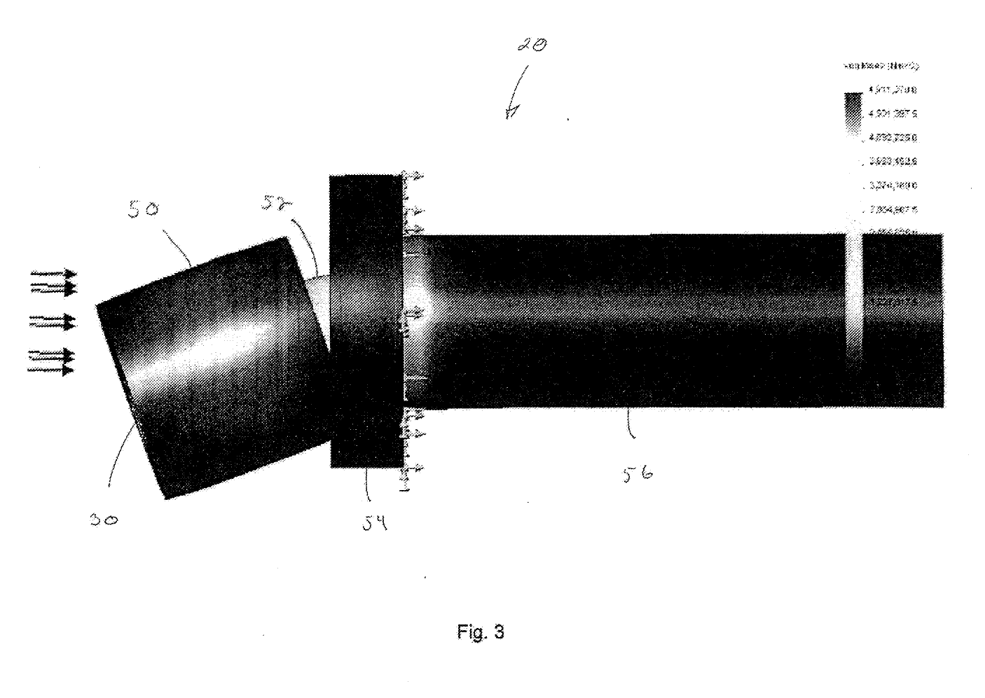

As shown in cross section in FIG. 2 and in a more detailed stress-analysis plot in FIG. 3, valve plug body 20 includes a plug face 30 and various other optional design features. These include a “head” section 50 adjacent a “neck” section 52 followed by a “shoulder” section 54 a stem or “torso” section 56 (to extend the analogy). The stem/torso 56 provides lateral stability within armature 18 and the shoulder 54 provides a reaction force to spring 22 (the relationship of which is best pictured in Detail A).

To close-off the valve, plug face 30 is pressed against a valve seat region 38 of the orifice body 34. (The “seat” region is typically just the highly-polished face or portion of the orifice body 34, though it may be otherwise configured in a conical shape, etc.) In which case, the neck region 52 operates as a living hinge 52 to accommodate misalignment (exaggerated in the plot of FIG. 3) of the plug face 30 and orifice body 34 when making a seal. Such a configuration offers the valve “compliance” in one domain. Stated otherwise, the plug head (50) can canter over the valve seat (38) because it bends over the circular groove (52) and therefore seals better. The relation of the groove to the adjacent sections defines the “living hinge” as will be understood by those with skill in the art.

A second domain of compliance concerns the selection of the plug material itself. The inventors hereof conducted an evaluation of “engineered” plastics. Early results concerning the durability of some of these materials was encouraging. However, some of the strongest materials have the same difficulty of metal seats. That is, valves incorporating the same have high leak rates when closed. Softer plastics seal well by “creeping” over time. However, the creep phenomenon causes control problems due to the fact that the seat would change shape depending on how long it was left closed versus how long it was left in an operating position.

Metal seals have a fairly high leak rate even with compliance, but the compliance does allow a usable product. Ultimately, the inventors were able to build a plastic valve plug that would seal, and control well, regardless of open and closed dwell times. Using a plastic selected with a very small amount of creep, which when coupled with the compliance of the living hinge feature, allowed almost perfect shutoff (for example, a few SSCM of leakage on a 50 SLPM controller at 5000 PSI).

Plastics suitable to this use range in tensile strength from about 10,000 PSI to about 20,000 PSI. Certain unfilled materials, and others with tensile strengths below 10,000 PSI showed large amounts of creep, making them unusable over time as the excessive creep changed the shape of the sealing surface to the point where the control function is disrupted, or the armature run out of stroke to account for the creep. Materials with tensile strength values above about 20,000 PSI showed little or no creep. But they offered none of the benefit of creep, when it comes to reducing leakage.

Also discovered was the fact that reinforced plastics worked better than non-reinforced plastics. However, fiber reinforced plastics offered sub-optimal performance. Not to be bound by any particular theory, but it is conjectured that the poor performance was due in part due to force flow/transmission paths along fibers in the material. Moreover the material is difficult to machine in leaving a high quality surface finish for the face of the valve plug resulting in higher leak rates. Powder reinforcements worked better, because they offered increased toughness to the valve plug without the bias of fibers and/or difficulty in any finish machining.

A most preferred selection of material for the subject application is PLAVIS Polyimide with 15% carbon powder reinforcement providing a tensile strength of 15,400 PSI. This material is similar to a more well-known polymer by DuPont called VESPEL SP-21 which is also advantageously employed. Another desirable reinforcement material comprises molybdenum disulfide. A range of fill reinforcement from about 5% to about 40% by weight is advantageously used. Absent the fill, undesirable creep can result.

### EXAMPLE 1

### Material Selection With Excessive Cold Flow

Employing un-filled PLAVIS, a valve was setup to operate at 5000 PSIG. Leak by was about 15 SCCM. The test unit was then left with the valve shut off over the 4 days. At the end of that period, the leak by indicated 0.6 SCCM. Upon inspection of the valve plug there was no indication of damage. Putting the unit back under 5000 PSIG, the valve would over shoot, but control. The large amount of creep over long periods of time meant that the shape of the sealing surface varied depending on the amount of time it was subjected to pressure. After changing controller PID settings, the valve behaved acceptably. Despite the advantages of reduced leak, however, the change in shape of the plug necessitated controller modification which is unacceptable for a commercial product.

### EXAMPLE 2

### Acceptable Material Selection and Improvements

Using a plug constructed of VESPEL SP-21, the surface finish and component alignment factor into how well the valve seals. Attaining 1% or less leak involved taking an assembled plug assembly to a lathe and cutting a new face on the plug head material, followed by a polishing operation to provide for acceptable feature alignment. With the same material, after cutting a circular groove into the body to allow a degree of flex to the plug, leak-free operation is attained without the need for the stated post-assembly machining.

As tested, and further shown and described, the plug head is able to cant or hinge with up to about four times the deflection of the same body without a hinge. Configurations allowing for at least twice the flexibility of will still offer value. In the configuration shown, the neck is about 1 mm in diameter as compared to the face (and cylinder head) of the valve plug that is about 2 mm in diameter.

### Variations

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of matching other than cross-correlation can be used.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The inventive subject matter includes the methods set forth herein in terms of method of manufacture, assembly and/or use. Also, it is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity. Also, the inventors intend that only those claims which use the words “means for” are intended to be interpreted under 35 USC 112, sixth paragraph. Moreover, no limitations from the specification are intended to be read into any claims, unless those limitations are expressly included in the claims.

All references cited are incorporated by reference in their entirety. Although the foregoing invention has been described in detail for purposes of clarity of understanding, it is contemplated that certain modifications may be practiced within the scope of the appended claims.

1. A valve plug operable in a valve assembly to be used in apposition to a valve seat to fully seal a valve orifice up to about 5000 PSI, the improvement comprising: the valve plug being made of plastic.

2. The valve plug of claim 1, wherein the plastic has a tensile strength between about 10,000 and about 20,000 PSI.

3. The valve plug of claim 1, wherein the plastic is reinforced by a non-fiber filler.

4. The valve plug of claim 3, wherein the non-fiber filler comprises particulate reinforcement selected from carbon powder and molybdenum disulfide.

5. The valve plug of claim 1, comprising a living-hinge region adjacent a seat head region.

6. The valve plug of claim 5, further comprising a stem region adjacent to the living-hinge region, opposite the seat head region.

7. A valve plug comprising:
a. a plastic body:
a. having a tensile strength of about 15,000 PSI, wherein the plastic is reinforced by a non-fiber filler,
b. a living-hinge region adjacent a seat head region (term needs definition in spec);
c. a stem region (term needs definition in spec) adjacent to the living-hinge region, opposite the seat head region; and
b. A valve seat surrounding a valve orifice;
c. a plastic valve plug adjacent to the valve seat that seals the valve orifice at up to about 5000 PSI.
